(19) United States
(12) Patent Application Publication
(10) Pub. No.: US 2012/0298138 A1
(43) Pub. Date: Nov. 29, 2012

(54) PROCESS FOR CLEANING SURFACES USING DRY ICE

(76) Inventors: Don Gurley, Ladson, SC (US); Rick Jones, North Charleston, SC (US); Karen Bruer, Hayes, VA (US); Thomas Devine, Chesapeake, VA (US); Mike Quinn, Chesapeake, VA (US)

(21) Appl. No.: 13/478,607

(22) Filed: May 23, 2012

Related U.S. Application Data
(60) Provisional application No. 61/490,323, filed on May 26, 2011.

(51) Int. Cl. B08B 7/00

(52) U.S. Cl. 134/7

(57) ABSTRACT

Metal surfaces may be cleaned using a dry ice (CO₂) blasting processes. Once cleaned, the surfaces are ready to be painted. The process of this invention is especially useful on ships where there are numerous metal surfaces that are subject to dirt and corrosions. The proper operating parameters for each of the types of metal surfaces require exacting conditions. These parameters include the size of the dry ice pellets, the discharge rate of the ice pellets, the type of nozzle being used and the flow rate of the pellets, the pressure of the pellets leaving the nozzle. The dry ice cleaning processes of the present invention eliminates secondary waste streams and moisture, leaving the treated surfaces immediately ready for painting. Only the dirt, loose paint, debris and other surface contaminants removed during the dry ice cleaning process need to be cleaned up prior to preservation and/or painting and return to service.

### CROSS-REFERENCE TO RELATED APPLICATIONS

The contents of Provisional Application U.S. Ser. No. 61/490,323 filed May 26, 2011, on which the present application is based and benefit claimed under 35 U.S.C. §119(e), is herein incorporated by reference.

### BACKGROUND OF THE INVENTION

1. Field of the Invention

The present invention relates to a process for cleaning metal surfaces using dry ice blasting. More specifically, the present invention relates to a process for dry ice cleaning of ferrous and non-ferrous metal surfaces to remove dirt, loose paint, debris and other surface contaminants in preparation for painting.

2. Description of Related Art

Painted metal surfaces exposed to the elements and regular usage accumulate grit, grim, grease, oil and other contaminates which are deleterious to the painted surface of the metal and sometimes results in chipped and peeling paint. These metal surfaces must be painted from time to time to maintain the integrity of the metal surface and to maintain the safety of those using the equipment or in contact with walkways, stairs and the like.

Before painting, the metal surfaces on ships the surfaces must be cleaned. Hand cleaning metal surfaces using brushes, scrapers and chemicals to remove accumulated debris is time consuming and expensive. Traditional mechanical approaches use high pressure air to accelerate solid abrasive particle (often sand or steel grit) to high speeds, which then impact the surface being cleaned. These methods, while largely effective, result in large amounts of waste that include the abrasive material, loose paint and debris being removed from the metal surface, as well as requiring significant time and labor to remove blast media and moisture from surfaces prior to preservation and return to service. Yet another drawback of the traditional grit blasting is the possible damage it causes to the metal surface being cleaned. Furthermore, the surfaces must be maintained in a cleaned condition until the actual painting is done to minimize contaminants which might develop on the metal surfaces.

The use of dry ice pellets for blast cleaning is well known in the art. In such systems, pellets of dry ice are drawn into a stream of compressed air by the action of a venture in a blast gun where the pellets are entrained into the gas stream and blasted out of the gun to impinge against the surface to be cleaned. After the pellets collide with the surface, removing unwanted surface coverings by their impact, the pellets sublime into gaseous CO₂ and become part of the atmosphere.

Despite prior efforts to provide suitable processes for effectively cleaning metal surfaces in preparation for painting, there remains a desire to have a process that cleans metal surfaces in need thereof that does not require removal of the blasting material.

### SUMMARY OF THE INVENTION

It is therefore the general object of the present invention to provide a process for cleaning metal surfaces, ferrous and non-ferrous metal surfaces, in preparation for painting.

Another object of the present invention is to provide a dry ice cleaning process for removing dirt, loose paint, debris and other contaminants from metal surfaces, while leaving only the removed materials for cleanup thereby making cleanup less expensive and less time consuming.

Yet another object of the present invention is to provide a process for preparing metal surfaces, especially those on ships, for painting.

It has been found that metal surfaces, both ferrous metals and non-ferrous metals, may be cleaned using the dry ice (CO₂) blasting process of the present invention. Once cleaned, the surfaces are ready to be painted. The process of this invention is especially useful on ships where there are numerous metal surfaces that are subject to dirt and corrosions. Some of these surfaces include, for example, vertical package conveyors (VPC), exterior deck and non-skid areas, bilges, tanks, electrical switchboards and electrical components, jet blast deflectors, gas turbine engines, auxiliary power units, various elevators and fire damaged spaces.

The proper operating parameters for cleaning the metal surfaces of each type of equipment require exacting conditions. These parameters include, for example, the size of the dry ice pellets, the discharge rate of the dry ice pellets, the type of nozzle being used, the flow rate of the pellets and the pressure of the pellets leaving the nozzle. The dry ice cleaning process of the present invention eliminates secondary waste streams and moisture, leaving the treated surfaces immediately ready for painting. Only the dirt, loose paint, debris and other surface contaminants removed during the dry ice cleaning process need to be cleaned up prior to preservation and/or painting and return to service. In most applications the debris can be removed through vacuuming or sweeping without the significant labor and time resources required with traditional cleaning methods. Because pelletized CO₂ is the only chemical ingredient used in the cleaning process of this invention, the process of this invention is carbon net zero, as the sublimated CO₂ is returned to the atmosphere.

### DESCRIPTION OF THE PREFERRED EMBODIMENT(S)

The present invention now will be described more fully hereinafter, in which preferred embodiments of the invention are shown. This invention may, however, be embodied in many different forms and should not be construed as limited to the embodiments set forth herein; rather these embodiments are provided so that this disclosure will be through and complete and will fully convey the scope of the invention to those skilled in the art.

It has been found that dry ice cleaning of metal surfaces, of both ferrous metals, like steel and stainless steel, and non-ferrous metals like aluminum, copper/nickel alloys and nickel/chromium alloys, such as Inconel®, not only removes surface debris and contaminants, such as bacteria and the like, but also reduces surface chloride ion concentrations more easily and more effectively than traditional cleaning methods. This reduction improves paint adherence and in the case of potable water tanks reduces the need for extensive super-chlorination flushes. The metal surfaces of vertical package conveyors (VPC), non-skid areas, bilges, tanks, and electronic switchboards, jet blast deflectors, gas turbine engines, auxiliary power unites, various elevators and fire damaged spaces, such as those found aboard ships, are particularly subjected to the accumulation of grit, grim, grease, oil and other contaminates which are deleterious to painted surfaces. The proper operating parameters for cleaning the metal surfaces of each type of equipment require exacting conditions.

It should be appreciated that the term “dry ice,” as used herein, is for basic explanation and understanding of the operation of the process of this invention. Therefore, the term “dry ice” is not be construed as limiting the cleaning processes of this invention and any material or combination of materials capable of sublimation upon impact can be used without departing from the spirit and scope of the invention.

As used herein the term “clean” means the absence of foreign material which could, if present, interfere with the function of these systems and components. The surface is visually free of grease, oil, scale, dirt, loose particles, and any other contamination foreign to the systems and components. Light dust on cleaned surfaces is not objectionable, provided that the quantity and size of the particle does not adversely affect the system operations. Tightly adherent corrosion products typical for the type of material to be cleaned are acceptable.

The process of this invention employs existing commercial grade dry ice supplying equipment and uses closely controlled parameters to conduct cleaning operations wherein dry ice pellets are fed under pressure through a hose to a nozzle and blasted against the metal surface to dislodge debris and remove contaminates. If improperly applied, the cleaning processes can damage or destroy painted surfaces, erode the metal surfaces and damage electrical components. Pelletized CO₂ is the only chemical ingredient used in cleaning processes of this invention. The CO₂ sublimates on impact with the surface being treated, expanding to nearly 800 times the original size of the pellet. Thus, the process of this invention is carbon net zero, as the CO₂ is returned to the atmosphere. During the dry ice blasting process, the energy required to change from a solid to a gas essentially “knocks” contaminants from the surface. This sublimation cleans deeply into the substrate of metals, adding the additional benefit of greatly increasing the time lapse prior to the formation of rust, virtually eliminating the flash-rust phenomenon.

The dry ice cleaning process of the present invention eliminates secondary waste streams and moisture leaving the treated surfaces immediately ready for painting. Only the dirt, loose paint, debris and surface contaminants removed during the dry ice cleaning process need to be cleaned up prior to painting and return to service. In most applications cleanup is done through vacuuming and/or sweeping of the debris without the significant labor and time resources required with traditional cleaning methods. Disposal of contaminants is easy because there is less to dispose of.

The dry ice is provided by a machine referred to as a “blaster”. The blaster includes a pelletizer with air dryer and feed system, an air compressor, and accompanying high pressure hose equipment. The air compressor may be of any commercial type but a screw-type air compressor, having a rating of air flow at a range up to 500 ft³/min at maximum pressure. However, an air flow of between about 200 ft³/min to about 300 ft³/min is preferred. Different pressures will be used for cleaning the difference metal surfaces cleaned by the process of this invention including the type of contaminant being removed that the thickness of the contaminant. There are a number of commercially available pelletizers in the method of this invention such as pelletizers from Triventek.

In various treating processes, such as cleaning vertical package conveyors (VPC), non-skid areas, bilges, potable water tanks, electrical switchboards and electrical components, the dry ice pellet will vary in size depending upon the surface conditions to be treated but is generally between about 2.5 mm and about 3.5 mm in diameter, most preferably about 2.9 mm in diameter. The shape of the pellets may be somewhat spherical but the shape varies from rice-like to being in the form of a rod. The dry ice flow rate will vary, depending upon the surface being cleaned, between about 2 lbm/hr for vertical package conveyors and switchboard/electronic equipment and about 3 lbm/hr for non-skid areas and bilges.

The capability of the dry ice blaster to remove debris from the surface being treated is dependent upon the strength of air compressor discharge which ranges from a rate of about 50 psi to about 200 psi of pressure of around 250 psi. is preferred. The air compressor humidity requirements range from about 20° F. to about 40° F. reduction in dew point from suction to nozzle discharge. As stated, the operating parameters of the process of this invention will vary depending upon the particular equipment or surface that is to be cleaned with the more sensitive equipment requiring less intensive parameters. For example, when cleaning an electrical switchboard, it has been found that a dry ice rice pellets that is 3 mm blasted through an air compressor set at 50 psi to start and gradually increasing to 100 psi is quite suitable.

The particular application of the process of this invention preferably uses a specific nozzle. For example, when cleaning the metal surface of vertical package conveyors a 90° fan nozzle type is used. When cleaning the metal surfaces of non-skid areas and bilges a shotgun-type nozzle is used. A shotgun nozzle is a rectangular outlet in a nozzle that has a direct blast pattern. When cleaning the surface of an electrical switchboard or other electronic equipment a 45° fan with ice crushing nozzle or hose is preferred.

The rate at which the nozzle is passed over the surface to be cleaned and the type of extrusion of the dry ice is likewise important. More specifically, a nozzle sweep rate of about 8 to 12 ft²/min., preferably about 10 ft²/min., is used when cleaning vertical package conveyors, non-skid areas and bilges. However, a nozzle sweep rate 3 to 5 ft²/min., preferably about 4 ft²/min., is used when cleaning the surface of an electrical switchboard or other electronic equipment. In all cases the dry ice is blasted onto the metal surface, expect when cleaning the surface of an electrical switchboard or other electronic equipment where bursts of dry ice pellets are used.

Other parameters for achieving a clean surface include using the correct angle of impingement of the dry ice pellets which varies from about 25° to about 55° from parallel to the surface being cleaned, preferably from about 30° to about 45°. This applies to each of the cleaning processes discussed herein. To optimize the cleaning process, the nozzle is held about 6 inches to 18 inches from the surface being cleaned, preferably 3 inches to about 5 inches from the surface.

Only the dirt, loose paint, debris and other surface contaminants removed during the dry ice cleaning process need to be cleaned up prior to preservation and/or painting and return to service. In most applications the debris can be removed through vacuuming or sweeping without the significant labor and time resources required with traditional cleaning methods.

Furthermore, when cleaning potable water tanks, the surfaces must be continually cleaned with super chlorination flushes until the actual painting is done to minimize the contaminants which develop on the metal surfaces. Additionally, chloride concentrations on metal surfaces affect the ability to successfully conduct welding operations.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A process for cleaning metal surfaces having loose paint, debris and contaminants thereon comprising:
(a) blasting said metal surface with an amount of dry ice pellets sufficient to dislodge at least a substantial portion of the dirt, loose paint, debris and contaminants from said metal surface to provide a clean metal surface; and
(b) removing said dislodged dirt, loose paint, debris, and contaminants from said cleaned surface.

2. The process according to claim 1 further comprising painting said clean metal surface.

3. The process according to claim 2 wherein said metal surface is a member of the group consisting of vertical package conveyors (VPC), exterior deck and non-skid areas, bilges, potable water tanks, electrical switchboards and electrical components, jet blast deflectors, gas turbine engines, various elevators and fire damaged spaces

4. The process according to claim 1 wherein said metal surface is a ferrous metal.

5. The process according to claim 1 wherein said ferrous metal is a member of the group consisting of iron and stainless steel.

6. The process according to claim 1 wherein said metal surface is a non-ferrous metal.

7. The process according to claim 1 wherein said non-ferrous metal is selected from the group consisting of aluminum, copper/nickel alloys and inconel alloys.

8. The process according to claim 1 wherein said dry ice pellets have a diameter between about 2.5 mm and about 3.5 mm.

9. The process according to claim 1 wherein said dry ice pellets have a diameter between about 2.8 mm and about 3.2 mm.

10. The process according to claim 1 wherein said dry ice pellets are supplied from a feed system having an air compressor operating a pressure of 50 to about 250 psi by passing said pellets from the air compressor through an accompanying high pressure hose and nozzle at a flow rate of up to 500 ft³/min.

11. The process according to claim 1 wherein said dry ice pellets are supplied from a feed system having an air compressor operating at a flow rate of between about 200 ft³/min to about 300 ft³/min.

12. The process according to claim 1 wherein said dislodged loose paint, debris, and contaminants are removed from said cleaned metal surface using a vacuum.

13. The process according to claim 1 wherein said blasting is accomplished using a nozzle sweep of from about 8 ft²/min to about 12 ft²/min.

14. A process for cleaning ferrous or non-ferrous metal surface having dirt, loose paint, debris and contaminants thereon comprising:
(a) blasting said metal surface with dry ice pellets said dry ice pellets having a diameter between about 2.5 mm and about 3.5 mm at a pressure between about 50 to about 250 psi by passing said pellets from the air compressor through an accompanying high pressure hose and nozzle at a flow rate of up to 500 ft³/min. to dislodge at least a substantial portion of the loose paint, debris and contaminants from the metal surface to provide a clean metal surface;
(b) removing said dislodged loose paint, debris, and contaminants from said cleaned surface; and
(c) painting said clean metal surface.

15. The process according to claim 14 wherein said dry ice pellets have a diameter between about 2.8 mm and about 3.2.

16. The process according to claim 14 wherein said dry ice pellets are supplied from a feed system having an air compressor operating at a flow rate of between about 200 ft³/min to about 300 ft³/min.

17. The process according to claim 14 wherein said dislodged loose paint, debris, and contaminants are removed from said cleaned metal surface using a vacuum.
